(19) United States
(12) Patent Application Publication
(10) Pub. No.: US 2014/0019154 A1
(43) Pub. Date: Jan. 16, 2014

(54) Clinical Content Management System

(71) Applicants: Robert Bosch GmbH, Stuttgart (DE); Robert Bosch Healthcare Systems, Inc., Palo Alto, CA (US)

(72) Inventors: Julie Cheitlin Cherry, Milpitas, CA (US); Nick Pilch, Albany, CA (US); Stephen J. Brown, Woodside, CA (US)

(21) Appl. No.: 13/941,457

(22) Filed: Jul. 13, 2013

Related U.S. Application Data
(60) Provisional application No. 61/671,221, filed on Jul. 13, 2012.

(51) Int. Cl. G06Q 50/22; G06Q 10/06

(52) U.S. Cl. CPC G06Q 50/22; G06Q 10/06
USPC 705/2

(57) ABSTRACT

In one embodiment, a method of operating a clinical content management system includes providing a master server with a master content database including master content, providing at least one first derivative content database operably connected to the master content database, each of the at least one first derivative content databases including derived content derived from the master content, including new content in the master content database, identifying with the master server each of the at least one first derivative content databases including derived content related to the new content, issuing a notice of the new content based upon the identified at least one first derivative content database including derived content related to the new content, and tracking at the master server whether the new content is incorporated into the identified at least one first derivative content database including derived content related to the new content.

This application claims the benefit of U.S. Provisional Application No. 61/671,221 filed Jul. 13, 2012, the entire contents of which is herein incorporated by reference.

### FIELD OF THE INVENTION

This disclosure relates to a content updating system and, more specifically to a system used for revising and updating clinical content.

### BACKGROUND

Content revision management systems are well known. Some well-known internet sites, for example, allow collaborative editing of documents which are published by the site with a form of editing control maintained by the site. Other systems are designed to allow for open source collaborative editing of software code.

The above described systems enable a process wherein a content master is continuously updated through contributions from a large number of people in disparate locations. In some instances, a new version of a program can be created by branching the content master into a separate independent program that is then managed independently.

While the known systems are highly effective for their purpose, they are not well suited for use in a health-related content management system. In a health-related management system, a number of different entities may be pursuing independent protocols. Customers would typically defer from participation in a program where the ability to act independently is stifled. Moreover, rigid adhesion to a single protocol stifles ingenuity and therefor progress.

Of course, when each customer is pursuing their own protocol, the ability of other customers to rapidly learn from the advances of one customer is affected by the ability to rapidly alert the other customers using related protocols to the advances discovered by the one customer.

What is needed in health content management wherein content can be continuously updated, while at the same time allowing a large number of customer-specific variations of that content master. It would be further advantageous if the system could alert customers to the opportunity to review and approve/modify changes in any derivative programs that might depend on the updated master content. It would be further advantageous if customer modifications could be reviewed and used to modify the master content. Yet another benefit would be realized if modification of the master content was not limited to customer input, while maintaining the quality of any such non-customer modification.

### SUMMARY

In accordance with one embodiment, a method of operating a clinical content management system includes providing a master server with a master content database including master content, providing at least one first derivative content database operably connected to the master content database, each of the at least one first derivative content databases including derived content derived from the master content, including new content in the master content database, identifying with the master server each of the at least one first derivative content databases including derived content related to the new content, issuing a notice of the new content based upon the identified at least one first derivative content database including derived content related to the new content, and tracking at the master server whether the new content is incorporated into the identified at least one first derivative content database including derived content related to the new content.

Other features of the embodiments herein will be apparent from the drawings, and detailed description that follows below

### BRIEF DESCRIPTION OF THE DRAWINGS

FIG. 1 depicts a diagram of a distributed clinical content management system which allows for a variety of different content to be used by various customers while maintaining a master content database, and which can notify the customers when content in the master content database has been added which is related to content in a customer content database;

FIG. 2 depicts the master server of FIG. 1 showing modification routes which are used to update the master content database;

FIG. 3 depicts a process which is used in verifying the content which is added to the master content database;

FIG. 4 depicts a diagram of a partially distributed clinical content management system which allows for a variety of different content to be used by various customers while maintaining a master content database, and which can notify the customers when content in the master content database has been added which is related to content in a customer content database;

FIG. 5 depicts the master server of FIG. 2 showing modification routes which are used to update the master content database, along with a master session server which uses the master content in accordance with general or customized rules to generate dialogue and sessions;

FIG. 6 depicts the dialogue library database of FIG. 5 with general/best practices dialogues and custom dialogues using content from the master content database;

FIG. 7 depicts the program sessions database of FIG. 5 populated with dialogues from the dialogue library database of FIG. 5; and

FIG. 8 depicts a block diagram of a patient device which is used to display sessions to a patient and to gather patient data.

Although specific features of the embodiments are shown in some drawings and not in others, this is done for convenience only as each feature may be combined with any or all of the other features in accordance with the embodiments.

### DESCRIPTION

For the purposes of promoting an understanding of the principles of the disclosure, reference will now be made to the embodiments illustrated in the drawings and described in the following written specification. Descriptions of well-known components and processing techniques are omitted so as to not unnecessarily obscure the embodiments herein. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

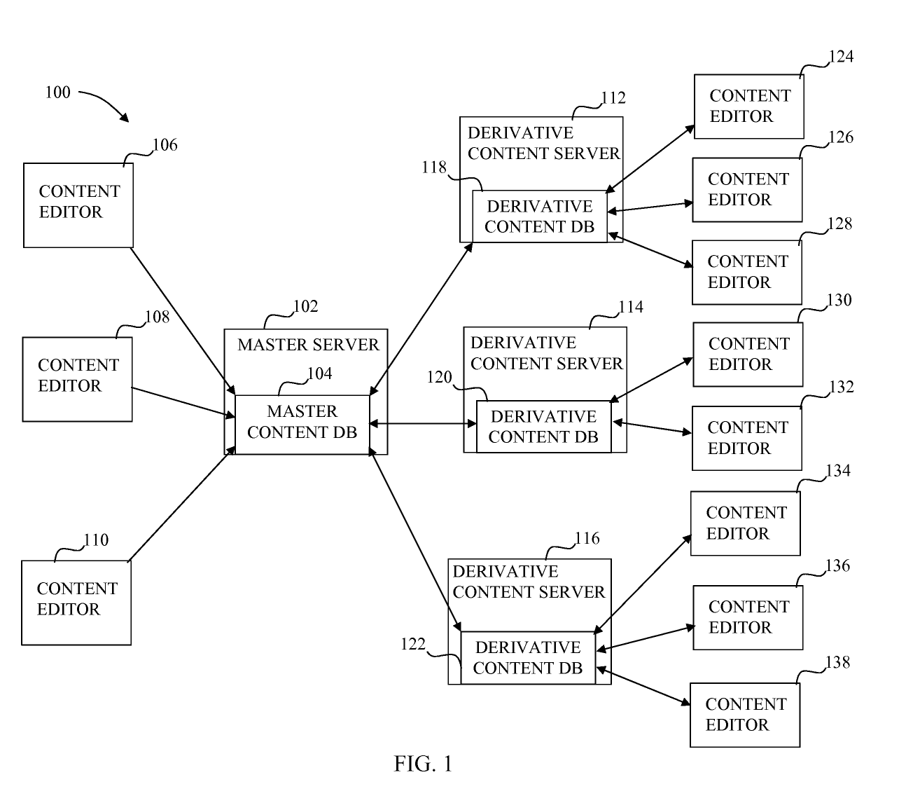

With initial reference to FIG. 1, a clinical content management system 100 is depicted. The clinical content management system 100 includes a master server 102 which includes a master content database 104. Content within the master content database 104 can be modified, as described more fully below, based upon input proposed by content editors 106, 108, and 110.

The content within the master content database 104 can also be modified based upon content modifications received from derivative content servers 112, 114, and 116. Each of the derivative content servers 112, 114, and 116 includes a respective derivative content database 118, 120, and 122. As will be discussed more fully below, the content within each of the derivative content databases 118, 120, and 122 is modified by associated content editors, and such modifications are added to the master content in the master content database 104. Specifically, content editors 124, 126 and 128 provide proposed modification to the derivative content database 118, content editors 130 and 132 provide proposed modification to the derivative content database 120, and content editors 134, 136 and 138 provide proposed modification to the derivative content database 122.

While the clinical content management system 100 includes only a single layer of derivative content servers (i.e., derivative content servers 112, 114, and 116 are in direct communication with the master server 102), in some embodiments one or more of the derivative content servers 112, 114, and 116 include one or more layers of further derivative content servers which hare thus only indirectly linked to the master server 102. Of course, direct connection to the master server 102 by the further derivative servers is also possible.

The “content” within the master content database 104 in one embodiment is in the form of questions to be posed to patients along with their related answers. Such questions may be for example “how are you feeling today?” or “do you have discoloration in your fingers?”. The content thus reflects current knowledge as to both indications of medical issues as well as the form of questions which are used in order to understand the medical condition of a patient. Because understanding of both medical symptoms and how individuals react to the manner in which questions are posed varies, the content in the master content database 104 is allowed to change.

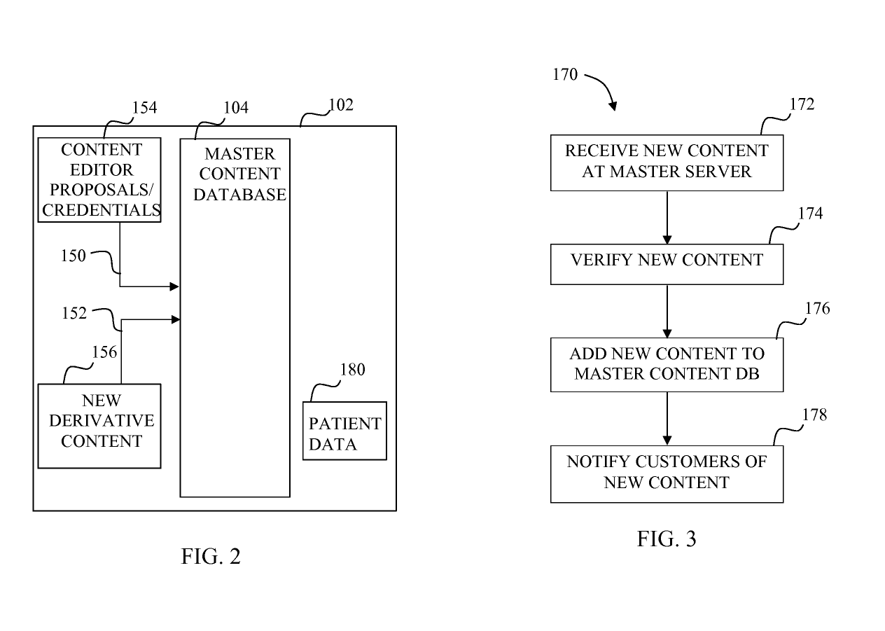

FIG. 2 depicts the master content database 104 within the master server 102. Also depicted are modification routes 150 and 152. New content from content editor proposals/credentials database 154 is incorporated into the master database 104 by the modification route 150 while new content from new derivative content database 156 is incorporated into the master database 104 by the modification route 152. While either modification route 150 or 152 can be used to modify the content within the master content database 104, the manner in which proposed new content is incorporated varies based upon the source of the new content.

Specifically, when new content is submitted by one of the content editors 106, 108, or 110, the proposed new content from the content editors 106, 108, or 110 enters the master server 102 at the content editor proposals/credentials database 154. The new content is accompanied by the credentials of the particular content editor and the basis for the change. For example, the credentials may include the laboratory or school/research team which is submitting the new content and the credentials may include a study or research project which supports the new content. The credentials may further be the name of the author generating the new content, the name of an expert panel that reviewed the new content, or the citation of an article related to the new content.

The modification route 150 entails a review of the proposed new content along with the associated credentials of the content editor 106, 108, or 110. The review is conducted by an expert panel. The expert panel may accept the new content for addition to the master content database, reject the new content, or determine that a modified version of the new content is to be added to the master content database.

Upon addition to the master content database, the new content is provided with a metatag. The metatag is used, among other purposes, to track the relationship of the new content to other content in the master content database. For example, if an original master content was a question in the form of “do you have any discoloration in your extremities?” and the new content was a question in the form of “do you have any discoloration in your fingers?”, the new content would be designated as a derivative of the original content. Significantly, the new content does not replace the original content. Thus, even if the new content is not as effective as the old content in obtaining the desired information, the new content is still added. The more effective question (old content or new content), however, would be identified as the “best practices” form of the question.

Because the new content does not replace the old content, duplication of efforts is avoided. For example, a customer attempting to improve the phrasing of a question would be able to access the master content database 104 and ascertain that a particular phrasing has already been attempted. Additionally, when the new content is accepted or modified, the reasons for the change, the citations, references and the supporting materials are stored along with the accepted or modified content in the master content database. Thus, the credentials/basis of the entity which submitted the content would also be available for review so that the customer could determine for themselves the credibility of the conclusions drawn.

New content is submitted to the new derivative content database 156 whenever one of the derivative content databases 118, 120, or 122 is modified. The new content is accompanied by the credentials of the particular content editor and the basis for the change which is similar to the process described above for the content editor proposals/credentials database 154. The modification route 152 also entails a review of the new content along with the associated credentials. Because the new content is already in one of the derivative content databases 118, 120, or 122, however, the new content will always be added to the master content database 104. The derivative content databases 118, 120, or 122 thus function as content editors of the master content database 104. In instances where the new content is not designated as source confidential (i.e., allowed to be shared with other customers), the expert panel assesses the new content to determine if the new content is to be designated as a best practice. The new content is otherwise handled in the same manner as the new content arriving from the modification route 150.

Returning to FIG. 1, the derivative content servers 112, 114, and 116 are each associated with the various content editors 124-138. The derivative content databases 118, 120 and 122 may be updated in a manner similar to the manner in which the master content database 104 was updated. In some embodiments, a sole content editor will be the owner of the derivative content server (the customer). Accordingly, the customer may modify the derivative content database based upon their own research efforts or using a customized review process.

Once new content is added to the master content database 104, regardless of the pathway, the clinical content management system 100 makes the new content available to each of the derivative content servers 112, 114, and 116. The manner and form in which the content is made available can vary between the derivative content servers 112, 114, and 116. For example, derivative content server 116 may be configured to only maintain the best practices of a particular set of master content in the master content database 104. Accordingly, if the new content in the master content database is designated as a best practice in the selected set of master content, the derivative content database 122 is automatically updated. Typically, the customer will also be notified of the automatic update.

In instances wherein a customer does not simply maintain the best practices version of content on a derivative content server, an alert is issued from the master server when new content is added which is related to content maintained on the derivative content server. The alert or notification may be sent by email or by system messages that appear to the customer upon logging into the derivative content servers or through both processes.

Continuing with the example above, if the derivative content on the derivative content database 118 includes the question “do you have any discoloration in your extremities?” and the new content was a question in the form of “do you have any discoloration in your fingers?”, the customer operating the derivative content server 112 would be alerted to the new content. The customer could then accept the new content, typically by replacing the content in the derivative content database 118 with the new content, reject the new content, or modify the new content thereby creating another derivative new content.

Regardless of the customer's particular decision, the decision is transmitted back to the master server 102. Accordingly, the master server 104 tracks the version of content in each of the derivative content databases 118, 120, and 122. This allows the master server 102 to properly identify customers who should receive alerts/updates as new content is added to the master content database 104.

The general process of updating the master content and informing the customers of the master server 102 is summarized in process 170 of FIG. 3. At block 172, new content is received at the master server 102 in either the content editor proposals/credentials database 154 or the new derivative content database 156. The new content is then verified (block 174) using either the modification route 150 or 152. Upon verification, the new content is added to the master content database 104 (block 176) and the customers are notified of the availability of new content at block 178.

In addition to being a repository of content used to obtain patient data, the clinical content management system 100 further functions as a repository of patient data collected as indicated by patient data database 180 of FIG. 2. This allows for customers to compare results of the various customer endeavors, enabling additional insight into the effectiveness of the content in the master content database 104.

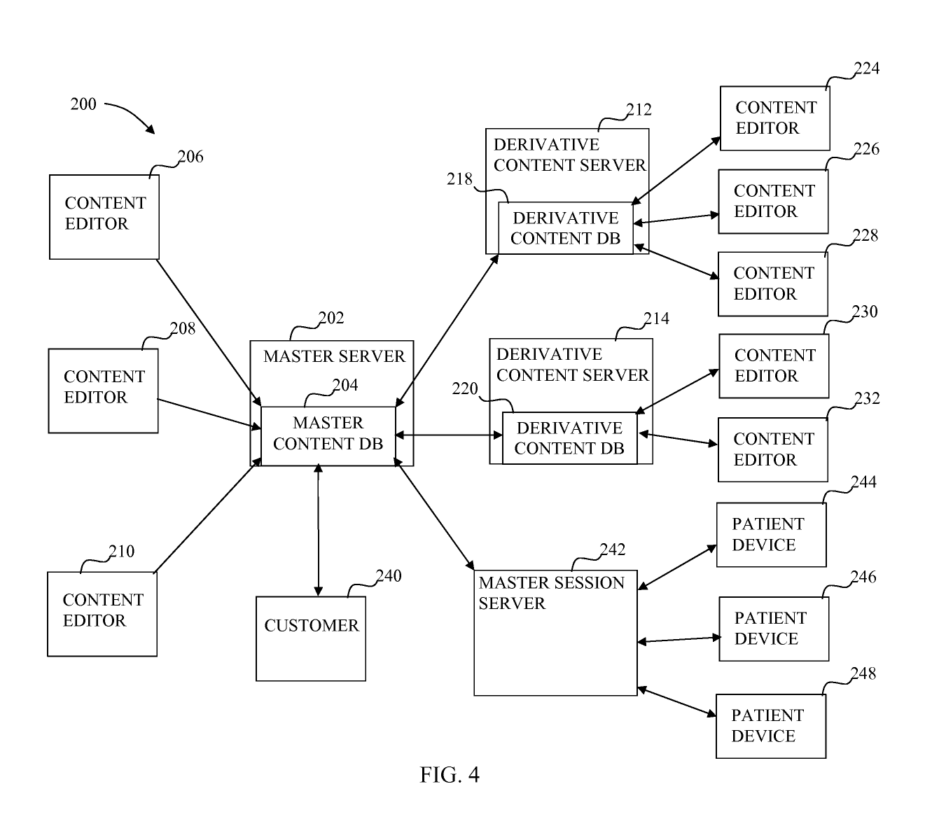

While the embodiment of FIG. 1 was described as a decentralized system, where use of the master content was controlled by the derivative content servers 112, 114, and 116, the clinical content management system 100 can be augmented by or replaced with a more centrally controlled system. For example, FIG. 4 depicts a clinical content management system 200 wherein some of the functions performed in the derivative content servers 112, 114, and 116 are performed centrally for some of the customers.

The clinical content management system 200 includes a master server 202 which includes a master content database 204. Content within the master content database 204 can be modified based upon input proposed by content editors 206, 208, and 210 in a manner like that described above for the clinical content management system 100.

Like the clinical content management system 100, the content within the master content database 204 can also be modified based upon content modifications received from derivative content servers 212 and 214 which function like the derivative content servers 112 and 114 of FIG. 1 using input from the master content database 204 and content from content editors 224, 226, 228, 230, and 232 to populate derivative content databases 218 and 220.

The clinical content management system 200 also includes a customer 240. The customer 240 does not maintain a derivative content database. Rather, the customer 240 relies upon the master server 202 and a master session server 242 for functions performed by the derivative servers 212 and 214. The master session server 242 thus provides dialogues to, and receives patient data from, patient devices 244, 246, and 248. While only one customer 240 is shown, the clinical content management system 200 may include any number of customers like customer 200. Moreover, while associated directly with the master server 202 and session sever 242, other customers may be associated with the derivative content server 212 and the derivative content server 214.

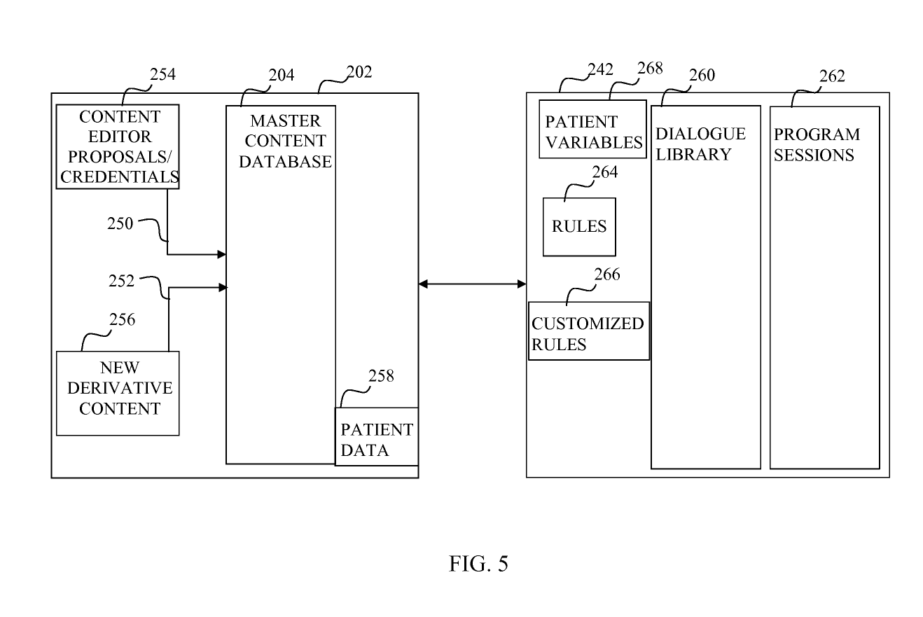

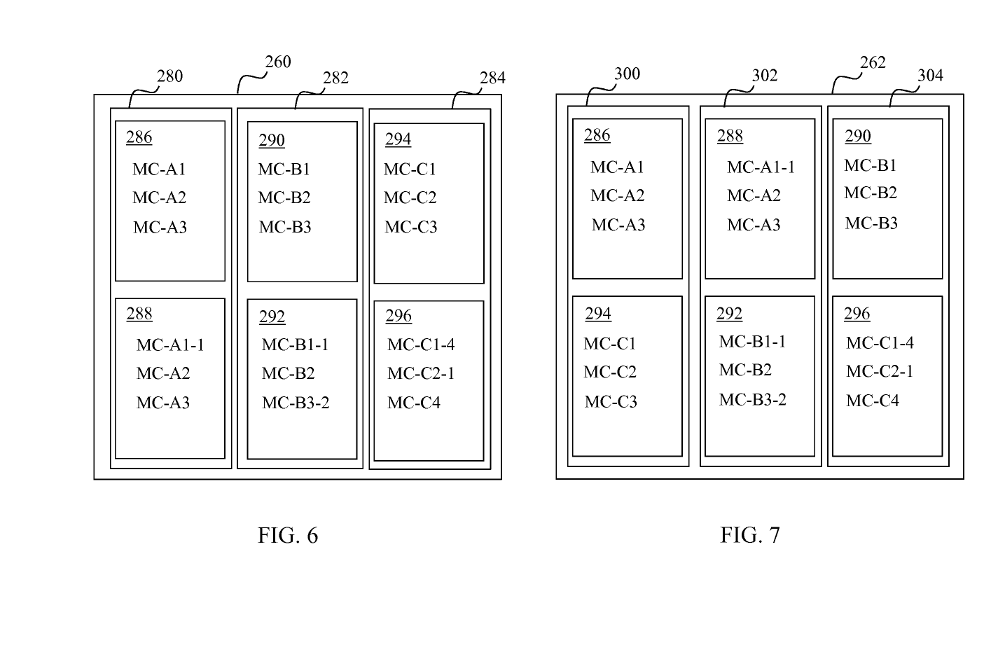

Some the functions provided by the session sever 242 are further explained with initial reference to FIG. 5. FIG. 5 depicts the master content database 204 within the master server 202. Also depicted are modification routes 250 and 252. New content from content editor proposals/credentials database 254 is incorporated into the master database 204 by the modification route 250 while new content from new derivative content database 256 is incorporated into the master database 204 by the modification route 252 in a manner similar to the processes described above with respect to modification routes 150 and 152. The master server 202 also includes a patient data database 258.

The master server 202 is in communication with the master session server 242 which includes a dialogue library 260 and program sessions 262. The master session server 242 further includes rules 264, customized rules 266, and patient variables 268. The rules 264 and customized rules 266 are used by the master session server 242 to populate sublibraries 280, 282 and 284 with, e.g., dialogues 286, 288, 290, 292, 294, and 296.

By way of example, dialogue 286 is generated by the rules 264 using the best practices master content (MC) for type (A) content while dialogue 290 is generated by the rules 264 using the best practices master content (MC) for type (B) content. Categorization and relationship of the master content, which include questions and other data, is tracked using the metatags associated with the master content. Type “A” content may be questions related to fatigue, while type “C” may be related to weight gain. In accordance with the rules 264, master content in the master content database 204 indicates that content MC-A1, MC-A2, and MC-A3 are the best practices content. Thus, the rules generate a best practices dialogue 286 for type “A” content. Dialogue 290 is similarly generated for type “B” content, and dialogue 294 is generated for type “C” content.

At least one customer, such as customer 240, has chosen to use a customized dialogue for at least a portion of a session that is to be given to a patient. Accordingly, the master session server 242 accesses the customized rules 266 and determines that a customized dialogue 288 is required. The customized rules 266 indicate that the customized dialogue 288, which includes type “A” content, should include both MC-A2 and MC-A3. In place of MC-A1, however, the customer 240 requires a derivative content in the form of MC-A1-1. MC-A1-1 is thus related to MC-A1, but is a variant.

Similarly, the customized rules 266 indicate that the customized dialogue 296, which includes type “C” questions, should include master content which is not the best practices content. Thus, in place of MC-C1, variant MC-C1-4 is used. Likewise, in place of MC-C2, variant MC-C2-1 is used. Moreover, a master content that is not related to the best practices content is required in the form of MC-C4.

Once the dialogue library 260 is populated (or modified based upon new master content), the program sessions database 262 is populated. The program sessions database 262 includes groups of dialogues from the dialogue library 260. The ordering and content of the sessions are governed by the rules 264, the customized rules 266 and patient variables 268. For example, for a customer who chooses to have their patients receive only the best practices master content for a particular condition, such as diabetes, the rules 264 would determine that type “A” and type “C” content should be used to create a session 300 which includes the best practices content of dialogues 286 and 294.

The session server 242 further generates sessions 302 and 304 for different customers (not shown) who have decided to use customized content for their patients, or for different patients of the customer 240. Accordingly, the customized rules 266 determine that session 302 should have the customized type “A” content of dialogue 288, along with a customized type “B” content of dialogue 292. The customized rules 266 further determine that session 304 should have the best practices type “B” content of dialogue 290, along with a customized type “C” content of dialogue 296.

The clinical content management system 200, like the clinical content management system 100, thus generates an assembly of content and the master content includes the manner in which various master content is strung together and branched, the order that questions appear, and how the questions are sequenced over time. A system which produces such content is described in U.S. Pat. No. 8,353,827 which issued on Jan. 15, 2013, the entire contents of which are herein incorporated by reference.

Accordingly, the clinical content management system 200 allows for each customer to use a customized protocol, while maintaining a comprehensive master content database 204. A software tool with logic capabilities may be used with the database tagging structure and customized rules to ensure that custom content is provided to the customer rather than the standard or best practices master content content. The best practices master content will only be used as the default version in the absence of a customized rule.

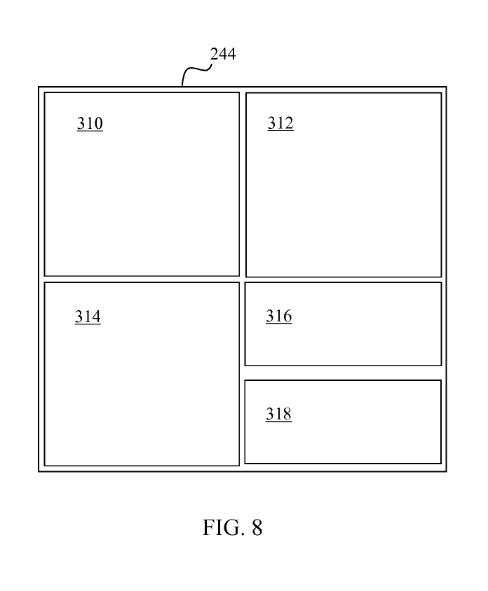

Once the appropriate session 300/302/304 has been generated, and in accordance with the patient variables, the master session server 242 establishes a link with the appropriate patient device 244/246/248. FIG. 8 illustrates a block diagram of the patient device 244 in accordance with one embodiment. The patient device 244 includes a processor 310, a memory 312, a display or other user interface 314, a sensor 316, and a communication unit 318. The memory 312 stores the session received from the master session server 242 through the communication unit 318 for execution by the processor 310. The content is displayed on the display 314, and user input in response to the session is stored in the memory 312 for transmission to the patient data database 258 where it is accessed by the customer 240. The user input is augmented with sensor data from the sensor 316 to produce the patient data.

Unlike previously known systems, where the disparate users are updating the master document until they decide to branch the program, in the embodiments above, the disparate users or customers are updating their own branch of content, which triggers a notice that affords the managers of the master content to incorporate the updates and changes from the derivative content, and vice versa.

In addition, in view of the fact that many different customers are running variations of the master content in systems that collect data from patients and track outcomes, each of the derivative content is in essence a separate track of a controlled experiment. If some medical groups/customers are obtaining better results from their derivative content, then that derivative content can be noted for its results and other users of the system can associate content variations with variations in results, using those results in their decision-making process for adapting their own derivative content. The disclosed system thus enables the continuous improvement of crowd-sourced or customer-sourced medical content based on results.

Moreover, when master reference content is changed for any reason, all derivative works may be located immediately and the revised content may be updated automatically or manually, or presented to the customer for a decision as to whether to update derivative content.

The disclosed medical content revision management system is extremely useful applications such as a remote health management program where content is automated over a network to interact with patients for the purpose of health monitoring, coaching and education. The system finds further utility in embodiments incorporating scripts used by nurses in call centers talking to patients over the phone, or in clinical guidelines and protocols for any kind of clinical practice, in the hospital, in the clinic, in home care settings, or in remote disease management. Moreover, the disclosed system can be used in any field that operates by guidelines using scripts and protocols that have a central authoritative content master with a large number of customer variations.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A method of operating a clinical content management system, comprising:
providing a master server with a master content database including master content;
providing at least one first derivative content database operably connected to the master content database, each of the at least one first derivative content databases including derived content derived from the master content;
including new content in the master content database;
identifying with the master server each of the at least one first derivative content databases including derived content related to the new content;
issuing a notice of the new content based upon the identified at least one first derivative content database including derived content related to the new content; and
tracking at the master server whether the new content is incorporated into the identified at least one first derivative content database including derived content related to the new content.

2. The method of claim 1, wherein including new content comprises:
receiving the new content from a content editor;
receiving credentials of the content editor;
reviewing the new content and credentials;
identifying the new content as related to a master content; and
tagging the new content based upon the identification of the new content as related to the master content.

3. The method of claim 2, wherein including new content further comprises:
receiving materials supporting the new content;
reviewing the received materials; and
including the new content based upon the received content.

4. The method of claim 1, further comprising:
providing a second derivative content database operably connected to the master content database, the second derivative content database including derived content derived from the master content;
including the new content in the second derivative content database prior to including the new content in the master content database; and
tracking at the master server that the new content is incorporated into the second derivative content database.

5. The method of claim 4, wherein including new content comprises:
receiving the new content from the second derivative content database;
receiving credentials associated with the new content;
reviewing the new content and credentials;
identifying the new content as related to a master content; and
tagging the new content based upon the identification of the new content as related to the master content.

6. The method of claim 1, wherein providing the master server with the master content database including master content comprises:
providing a first question related to a medical condition;
providing a plurality of allowed first answers to the provided first question;
providing a second question related to the medical condition;
associating the second question with one of the plurality of allowed first answers; and
providing allowed second answers to the provided second questions.

7. The method of claim 1, further comprising:
storing customized rules associated with a customer in a master session server;
identifying a subset of the master content using the customized rules;
generating a session including the subset of the master content; and
communicating the session to a patient of the customer.

8. The method of claim 7, further comprising:
identifying a relationship between the subset of the master content and the new content;
issuing a notice of the new content based upon the identified relationship between the subset of the master content and the new content; and
tracking at the master server whether the new content is incorporated into the subset of the master content identified using the customized rules.
